(19) United States
(12) Patent Application Publication
(10) Pub. No.: US 2019/0050698 A1
(43) Pub. Date: Feb. 14, 2019

(54) Apparatus and Method for Automatic Presence Monitoring in a Passenger Compartment

(71) Applicant: Siemens Aktiengesellschaft, Muenchen (DE)

(72) Inventors: Martin Jahn, Litschau (AT); Martin Schiefer, St. Poelten (AT)

(21) Appl. No.: 16/056,761

(22) Filed: Aug. 7, 2018

(30) Foreign Application Priority Data
Aug. 8, 2017 (DE) 102017213766.5

(51) Int. Cl. G06K 19/07; G01S 13/75; G01V 11/00

(52) U.S. Cl. CPC G06K 19/0723; G06Q 2240/00; G01V 11/00; G01S 13/75

(57) ABSTRACT

An apparatus and method for automatic presence monitoring in a passenger compartment, wherein the apparatus includes at least a first user medium that has a first transceiver unit and at least one detector module that has a second transceiver unit, where at least a first sensor and a second sensor are arranged on the at least first user medium, the first and second sensors having different operating principles and being configured to be mutually redundant in order to provide advantageous design conditions such that a presence of at least the first user medium in the passenger compartment is thereby detected with great reliability.

### BACKGROUND OF THE INVENTION

### 1. Field of the Invention

The invention relates to an apparatus and a method for automatic presence monitoring in a passenger compartment, comprising at least a first user medium, which has a first transceiver unit, and at least one detector module having a second transceiver unit.

### 2. Description of the Related Art

Accurate presence monitoring of user media, for instance, carried by passengers of public transport services, in passenger compartments of transport means (e.g. of railway carriages, subway trains, streetcars, buses, cable cars or suspended railways or autonomous vehicles) is very important.

Automatic presence monitoring for transport services that employ electronic tickets (e-tickets) is used in particular for performing electronic fare management (EFM) or for ticket billing, such as via Be-In-Be-Out (BiBo) monitoring. In BiBo monitoring, passenger journeys are detected automatically without passengers having to perform active operations when entering or leaving the passenger compartment (e.g., a passenger area of a streetcar).

The passengers must carry user media, e.g., radio-frequency identification (RFID) smart cards having personal signatures. Journeys can be assigned to the relevant passengers based on the signatures.

To ascertain the journey of a passenger, whether the passenger is in the passenger compartment must be verified. This is often associated with technical problems and/or insufficient accuracy.

The user medium usually comprises a wake-up receiver, which is activated by exposure to electromagnetic waves of specific frequencies (e.g., 110 Hz to 150 Hz or 6.78 MHz), known as wake-up signals, when the passenger, who is carrying the user medium, enters the passenger compartment.

For this purpose, owing to short ranges of the wake-up signals, suitable coils or antennas are provided at access doors to the passenger compartment.

Activation of the wake-up receiver activates a circuit of the user medium and creates a radio link from the user medium to a detector module of the passenger compartment. The radio link uses different frequencies from those of the wake-up signals, such as 868 MHz or 2.4 GHz. The detector module detects the user media present in the passenger compartment and transfers corresponding identification data to a processing unit of the detector module. A signal transmission between the user media and the detector module occurs at least once between two stops at which the transport means stops and a passenger change occurs.

DE 10 2012 009 610 A1 discloses a method and an apparatus for detecting and billing fares in a vehicle. User media carried by the passengers and a detection system of the vehicle are used to monitor the presence of passengers in a passenger compartment and to bill fares. In this case, detected acceleration profiles of the vehicle are compared with accelerations detected by the user media.

EP 2 945 127 A1 discloses a method and an apparatus for fare billing in a transport means, in which electronic tickets are detected. In this case, accelerations measured by accelerometers arranged on the tickets are compared with accelerations measured by an accelerometer provided in a detector unit of the transport means.

### SUMMARY OF THE INVENTION

It is an object of the invention to provide an improved apparatus and method for automatic presence monitoring in a passenger compartment that is more advanced than the prior art.

This and other objects and advantages are achieved in accordance with the invention by an apparatus in which at least a first sensor and a second sensor are arranged on the at least first user medium, which sensors have different operating principles and are configured to be mutually redundant.

This achieves particularly accurate presence monitoring of passengers in the passenger compartment. High reliability and measurement certainty, and hence high availability, of the apparatus are achieved by virtue of the first sensor and the second sensor on the first user medium and by virtue of their different operating principles. Measured values from the first sensor can be verified by measured values from the second sensor. In the event of failures, such as failure of the first sensor, the second sensor can compensate for the operation of the first sensor, i.e., the presence monitoring can be performed, at least temporarily, solely by the second sensor.

In addition, by virtue of the first sensor and the second sensor, there is no need for coils and antennas at the doors of the passenger compartment for transmitting short-range and low-frequency wake-up signals, thereby simplifying the design properties of the passenger compartment, and reducing installation expenses and achieving cost savings.

The detector module comprising the second transceiver unit merely needs to be provided in the passenger compartment for data transmission with the first user medium. The data transmission can be performed using electromagnetic waves of a specific frequency. An additional frequency, which is different from this frequency, is not needed for the wake-up signals.

Despite an absence of coils and antennas at doors of the passenger compartment and of wake-up signals transmitted by these antennas, the first user medium is present in the passenger compartment can be ascertained with high accuracy.

For instance, the first sensor can be formed as an accelerometer and can measure an acceleration.

The second sensor can be formed as a magnetic field sensor, for example, and can measure magnetic flux density, which together with a measured value from the first sensor and information identifying the first user medium is transmitted as a suitable signal from the first transceiver unit of the first user medium to the second transceiver unit of the detector module of the passenger compartment. The signal, or more precisely the magnetic flux density and the measured value from the first sensor, are evaluated in the detector module. If the magnetic flux density exceeds a specified threshold value relating to magnetic properties of the passenger compartment, and if evaluation results relating to the measured value from the first sensor and satisfy defined criteria, then it is ascertained that the first user medium is present in the passenger compartment.

An advantageous embodiment is achieved if the second sensor is in the form of an acoustic pressure sensor.

By virtue of this measure, ascertaining the presence of the first user medium in the passenger compartment can be performed based on specific sound emissions (e.g., announcements from an audio system in the passenger compartment).

It is advantageous if the at least first user medium is in the form of a cellphone. It is possible to dispense with tickets by virtue of this measure.

An advantageous embodiment is obtained when differences are formed from measured values at least from the first sensor and from a fourth sensor of a second user medium, when absolute values of the differences are formed, and when a presence at least of the first user medium and of the second user medium in the passenger compartment is ascertained when the absolute values do not exceed a specified tolerance and when measured values at least from the second sensor exceed a specified threshold value.

By virtue of this measure, it is possible to dispense with complex locating techniques for the first user medium and for the second user medium in the passenger compartment. All that is required are simple evaluations and comparisons of sensor measured values with threshold values and/or with one another.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below with reference to exemplary embodiments, in which, by way of example:

FIG. 1 shows a schematic diagram of a first user medium of an exemplary embodiment of an apparatus in accordance with the invention;

FIG. 2 shows a schematic diagram of a passenger compartment comprising an exemplary embodiment of an apparatus according to the invention; and

FIG. 3 is a flowchart of the method in accordance with the invention.

### DETAILED DESCRIPTION OF THE EXEMPLARY EMBODIMENTS

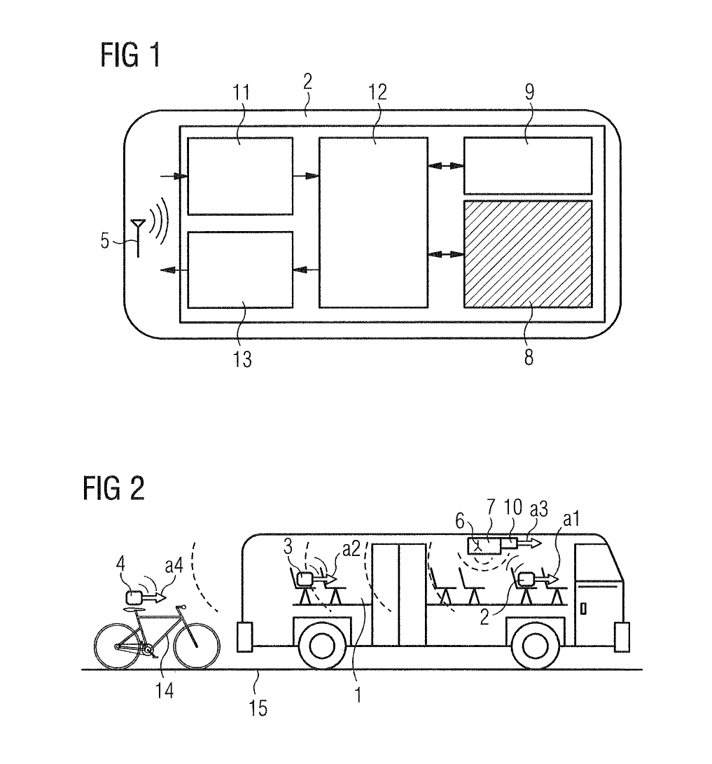

FIG. 1 shows a schematic diagram, or block diagram, of a first user medium 2, which is formed as an RFID smart card. Arranged thereon and connected by an electronic circuit (not shown in detail) are a first transceiver unit 5, a receiver 11, a microcontroller 12, a first sensor 8, a second sensor 9 and a transmitter 13.

The first transceiver unit 5, the receiver 11, the microcontroller 12 and the transmitter 13 are known from the prior art.

The first transceiver unit 5 is configured to perform transmit and receive operations of radio-frequency signals and transmits and receives electromagnetic waves or signals of frequency 2.4 GHz. The electronic circuit, or components thereon such as the microcontroller 12 and the first sensor 8 and the second sensor 9, are activated and supplied with electrical energy via the waves.

The signals, in which is encoded, for example, information on a fare to be debited for using a transport means, are routed via the receiver 11 into the microcontroller 12 and processed there. For instance, information about a fare credit, which information is stored in the microcontroller 12, which comprises a memory unit, can be reduced by a payable fare currently detected via the signal.

It is also possible, however, that no specific information is encoded in the signal, and fare debiting by a predefined debit amount is initiated by a signal reception without evaluation of signal contents.

The first sensor 8 and the second sensor 9 are connected to the microcontroller 12. The first sensor 8 is in the form of an accelerometer formed as a microelectromechanical system (MEMS) and known from the prior art. The second sensor 9 is formed as a Hall magnetic field sensor, likewise known from the prior art, and therefore has a different operating principle from the first sensor 8.

The first sensor 8 is used to measure accelerations of the first user medium 2, and the second sensor 9 is used to measure magnetic flux densities in an environment of the first user medium 2.

Information on measurement results from the first sensor 8 and from the second sensor 9 is routed to the microcontroller 12 and stored therein, encrypted and, together with information for identifying the first user medium 2, which information is stored on the microcontroller 12 and likewise is encrypted, transferred to the transmitter 13. In the transmitter 13, this information is converted into signals, i.e., suitably encoded in signals. The signals containing the information encoded therein are transmitted by the first transceiver unit 5 to a detector module 7, shown in FIG. 2, of a passenger compartment 1, also disclosed in FIG. 2, of the transport means.

The transmitted signals are evaluated and it is ascertained on the basis of evaluation results whether the first user medium 2 is present in the passenger compartment 1, i.e., automatic presence monitoring is performed. If it is ascertained that the first user medium 2 is present in the passenger compartment 1, then a fare is debited from the first user medium 2.

FIG. 2 discloses in a schematic diagram a passenger compartment 1 of a bus, in which compartment are present a first passenger (not shown) having a first user medium 2, and a second passenger (also not shown) having a second user medium 3. In accordance with the invention, it should be understood further passengers having further user media can also be present in the passenger compartment 1.

The first user medium 2 and the second user medium 3 are formed as the RFID smart cards described in connection with FIG. 1.

The first user medium 2 comprises, as shown in FIG. 1, a first transceiver unit 5, a first sensor 8, and a second sensor 9. The second user medium 3 comprises (not shown) a third transceiver unit, a fourth sensor, and a sixth sensor. The first sensor 8 and the fourth sensor are formed as conventional MEMS accelerometers, the second sensor 9 and the sixth sensor are formed, as is also known, as Hall magnetic field sensors.

The passenger compartment 1 comprises a detector module 7 comprising a second transceiver unit 6, which is configured to perform transmit and receive operations of radio-frequency signals of frequency 2.4 GHz, comprising a third sensor 10, which is formed as a conventional MEMS accelerometer, and comprising a processing unit, which is not shown.

The third sensor 10, which is formed as an accelerometer, thus has the same operating principle as the first sensor 8. It is also conceivable in accordance with the invention, however, that the third sensor 10 has the same operating principle as the second sensor 9, i.e., is in the form of a magnetic field sensor.

The second transceiver unit 6 and the third sensor 10 are connected to the processing unit via conduction paths, which are not shown.

A cyclist (not shown), who is carrying a third user medium 4, which is formed as an RFID smart card, is traveling on a bicycle 14 outside the passenger compartment 1.

The third user medium 4 comprises (not shown) a fourth transceiver unit, a seventh sensor, which is formed as a conventional MEMS accelerometer, and an eighth sensor, which, as is also known, is in the form of a Hall magnetic sensor.

In accordance with the invention, it is also conceivable that further user media are located outside the passenger compartment 1.

The bus and the bicycle 14 are traveling on a roadway 15 directly one behind the other.

The first sensor 8 measures a first acceleration a1 of the first user medium 2, the fourth sensor measures a second acceleration a2 of the second user medium 3, the third sensor 10 measures a third acceleration a3 of the bus, and the seventh sensor measures a fourth acceleration a4 of the third user medium 4.

The second sensor 9 measures a first magnetic flux density in an environment of the first user medium 2, the sixth sensor of the second user medium 3 measures a second magnetic flux density in an environment of the second user medium 3, and the eighth sensor of the third user medium 4 measures a third magnetic flux density in an environment of the third user medium 4.

Within a certain range of the detector module 7, a signal transmission takes place continuously between the second transceiver unit 6 on the one side, and the first transceiver unit 5, the third transceiver unit, and the fourth transceiver unit on the other.

As explained in connection with FIG. 1, as a result of this signal transmission, electronic circuits of the first user medium 2, of the second user medium 3, and of the third user medium 4 are activated and supplied with electrical energy.

Information for identifying the first user medium 2, i.e., a first electronic signature, and information on the measured first acceleration a1 and on the first magnetic flux density is transmitted continuously from the first user medium 2 to the detector module 7.

Information for identifying the second user medium 3, i.e., a second electronic signature, and information on the measured second acceleration a2 and on the second magnetic flux density is transmitted continuously from the second user medium 3 to the detector module 7.

Information for identifying the third user medium 4, i.e., a third electronic signature, and information on the measured fourth acceleration a4 and on the third magnetic flux density is transmitted continuously from the third user medium 4 to the detector module 7.

The first acceleration a1, the second acceleration a2, the third acceleration a3, and the fourth acceleration a4, and also the first magnetic flux density, the second magnetic flux density, and the third magnetic flux density are stored and evaluated in the processing unit of the detector module 7 continuously at defined time intervals.

In this process, differences are formed pair-by-pair based on the first acceleration a1, the second acceleration a2, the third acceleration a3, and the fourth acceleration a4 (for instance a first difference is formed between the first acceleration a1 and the second acceleration a2, a second difference is formed between the first acceleration a1 and the third acceleration a3, and a third difference is formed between the first acceleration a1 and the fourth acceleration a4, etc.), and absolute values formed from these differences.

In addition, the absolute values are compared with a specified tolerance, and the first magnetic flux density, the second magnetic flux density, and the third magnetic flux density are compared with a defined threshold value, continuously in the processing unit.

If the absolute values do not exceed the specified tolerance over a defined observation period, and the first magnetic flux density, the second magnetic flux density, and the third magnetic flux density exceed the specified threshold value, then it is ascertained that the first user medium 2, the second user medium 3 and the third user medium 4 are present in the passenger compartment 1. On ascertaining that the first user medium 2, the second user medium 3, and the third user medium 4 are present in the passenger compartment 1, signals containing suitably encoded information are transmitted to the first user medium 2, the second user medium 3, and the third user medium 4, which signals cause fares to be debited from a credit stored on the first user medium 2, the second user medium 3 and the third user medium 4.

For the first user medium 2 and the second user medium 3, the presence of these user media in the passenger compartment 1 is ascertained.

For the third user medium 4, which is moving outside the passenger compartment 1, i.e., is not present in the passenger compartment 1, the processing unit of the detector module 7 does not ascertain a presence because the fourth acceleration a4 differs significantly from the first acceleration a1, the second acceleration a2, and the third acceleration a3, and also the third magnetic flux density does not exceed the suitably specified threshold value.

It is possible, however, that the fourth acceleration a4 does not differ, at least temporarily, from the first acceleration a1, the second acceleration a2, and the third acceleration a3. Nevertheless, the third user medium 4 is not ascertained as present in the passenger compartment 1 provided the third magnetic flux density does not exceed the specified threshold value.

Moreover, the third user medium 4 is not ascertained as present in the passenger compartment 1 if the third magnetic flux density does exceed the specified threshold value but the fourth acceleration a4 differs from the first acceleration a1, the second acceleration a2, and the third acceleration a3 by more than the specified tolerance.

It is also possible in accordance with the invention that, in the same way as for the first acceleration a1, the second acceleration a2, the third acceleration a3, and the fourth acceleration a4, differences and absolute values are formed based on the first magnetic flux density, the second magnetic flux density, and the third magnetic flux density, and these absolute values are used, by checking whether they lie above or below a specified tolerance, for ascertaining a presence of the first user medium 2, the second user medium 3, and the third user medium 4 in the passenger compartment 1.

It is also conceivable in this case that the detector module 7 comprises a fifth sensor, which is formed as a conventional Hall magnetic field sensor, and that a fourth magnetic flux density, which is measured by this sensor, is used in ascertaining the presence of the first user medium 2, the second user medium 3, and the third user medium 4 in the passenger compartment 1.

It is also conceivable that although the detector module 7 comprises the second transceiver unit 6 and the processing unit, the detector module 7 does not comprise any other sensors. In this embodiment of the apparatus in accordance with the invention, a reference user medium containing corresponding sensors and in the same embodiment as the first user medium 2, the second user medium 3, and the third user medium 4 is provided in the passenger compartment 1, and is carried, for example, by a bus driver. For the purpose of ascertaining a presence of the first user medium 2, the second user medium 3, and the third user medium 4 in the passenger compartment 1, a signal transmission occurs between the detector module 7 on the one side, and reference user medium, the first user medium 2, the second user medium 3, and the third user medium 4 on the other, and information that is transmitted to the detector module 7 is evaluated in the processing unit. By virtue of the reference user medium provided in the passenger compartment 1, ascertaining presence is possible even when only the first user medium 2 is present in the passenger compartment 1 apart from the reference user medium.

In the event of the first sensor 8 failing, ascertaining presence for the first user medium 2 is performed, at least temporarily, solely based on the second sensor 9, or in the event of the second sensor 9 failing, is performed, at least temporarily, solely based on the first sensor 8, i.e., the first sensor 8 and the second sensor 9 are configured to be mutually redundant. In this case, however, to compensate for the failure, the observation periods for evaluating the first magnetic flux density or the first acceleration a1 must be increased.

It is also conceivable to form the second sensor 9, the fifth sensor, the sixth sensor and the eighth sensor as acoustic pressure sensors. Here, measured acoustic pressures are compared with reference acoustic pressures associated with sound emissions from stop announcements inside the passenger compartment 1.

Differences are formed from the acoustic pressures and the reference acoustic pressures, and absolute values formed from the differences, and a check is made to establish whether these absolute values lie above or below a specified tolerance. Results of this check are used in ascertaining the presence of the first user medium 2, the second user medium 3, and the third user medium 4 in the passenger compartment 1.

Furthermore, it is conceivable that the first user medium 2, the second user medium 3, and/or the third user medium 4 are in the form of cellphones known from the prior art. For this embodiment, suitable transceiver units, sensors and applications must be provided on the cellphones, which applications provide information for identifying the first user medium 2, the second user medium 3, and/or the third user medium 4, and provide a fare credit, which can be accessed. This information together with sensor information is transmitted as signals to the detector module 7 via the transceiver units.

Signals that cause fare prices to be debited from the fare credits stored via the applications on the cellphones are transmitted from the detector module 7 to the cellphones.

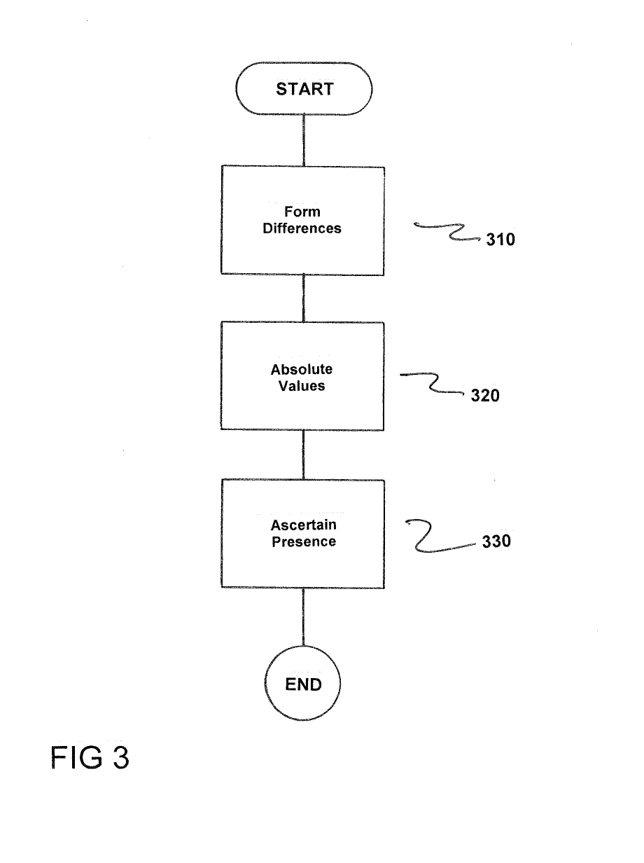

FIG. 3 is a flowchart of a method for automatic presence monitoring by an apparatus in a passenger compartment, where the apparatus includes at least a first user medium having a first transceiver unit and at least one detector module having a second transceiver unit, where at least a first sensor 8 and a second sensor 9 are arranged on the at least first user medium 2, and where the first and second sensors 8, 9 have different operating principles and are configured to be mutually redundant. The method comprises forming differences from measured values obtained by at least a first sensor 8 and by a fourth sensor of a second user medium 3, as indicated in step 310.

Next, absolute values of the formed differences are formed, as indicated in step 320. Next, a presence of at least a first user medium 2 and at least a second user medium 3 in the passenger compartment 1 is ascertained when the formed absolute values do not exceed a specified tolerance and when measured values from at least the second sensor 9 exceed a specified threshold value, as indicated in step 330.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for automatic presence monitoring in a passenger compartment, comprising:
at least a first user medium having a first transceiver unit; and
at least one detector module having a second transceiver unit;
wherein at least a first sensor and a second sensor are arranged on the at least first user medium, said first and second sensors having different operating principles and being configured to be mutually redundant.

2. The apparatus as claimed in claim 1, wherein the at least first sensor comprises an accelerometer.

3. The apparatus as claimed in claim 1, wherein the second sensor comprises a magnetic field sensor.

4. The apparatus as claimed in claim 2, wherein the second sensor comprises a magnetic field sensor.

5. The apparatus as claimed in claim 1, wherein the second sensor comprises an acoustic pressure sensor.

6. The apparatus as claimed in claim 2, wherein the second sensor comprises an acoustic pressure sensor.

7. The apparatus as claimed in claim 1, wherein the first transceiver unit and the second transceiver unit are configured to transmit and receive operations of radio-frequency signals.

8. The apparatus as claimed in claim 1, wherein the at least first user medium comprises a Radio Frequency Identification (RFID) smart card.

9. The apparatus as claimed in claim 1, wherein the at least first user medium comprises a cellphone.

10. The apparatus as claimed in claim 1, wherein the at least one detector module comprises at least a third sensor having an operating principle which is the same as the first sensor.

11. The apparatus as claimed in claim 1, wherein the at least one detector module comprises at least a third sensor having an operating principle which is the same as the second sensor.

12. The apparatus as claimed in claim 11, wherein differences are formed from measured values from at least the first sensor and from the third sensor, absolute values of the differences are formed, and a presence of at least the first user medium in the passenger compartment is ascertained when the formed absolute values do not exceed a specified tolerance and when measured values from at least the second sensor exceed a specified threshold value.

13. The apparatus as claimed in claim 12, wherein differences are formed from measured values from at least the second sensor and from a fifth sensor of the at least one detector module; wherein absolute values of the formed differences are formed; and wherein a presence of at least the first user medium in the passenger compartment is ascertained when the absolute values do not exceed a specified tolerance.

14. The apparatus as claimed in claim 13, wherein differences are formed from measured values from at least the second sensor and from a sixth sensor of a second user medium; wherein absolute values of the differences are formed; and wherein a presence of at least the first user medium and the second user medium in the passenger compartment is ascertained when the absolute values do not exceed a specified tolerance.

15. The apparatus as claimed in claim 12, wherein presence for the at least first user medium in an event of failure of the at least first sensor failing is ascertained, at least temporarily, solely based on the second sensor, and in an event of the second sensor failing, at least temporarily, based solely on the at least first sensor.

16. The method as claimed in claim 13, wherein presence for the at least first user medium in an event of failure of the at least first sensor failing is ascertained, at least temporarily, solely based on the second sensor, and in an event of the second sensor failing, at least temporarily, based solely on the at least first sensor.

17. The method as claimed in claim 14, wherein presence for the at least first user medium in an event of failure of the at least first sensor failing is ascertained, at least temporarily, solely based on the second sensor, and in an event of the second sensor failing, at least temporarily, based solely on the at least first sensor.

18. A method for automatic presence monitoring by an apparatus in a passenger compartment, the apparatus including at least a first user medium having a first transceiver unit and at least one detector module having a second transceiver unit, at least a first sensor and a second sensor being arranged on the at least first user medium, said first and second sensors having different operating principles and being configured to be mutually redundant, the method comprising:
forming differences from measured values obtained by at least a first sensor and by a fourth sensor of a second user medium;
forming absolute values of the formed differences; and
ascertaining a presence of at least a first user medium and at least a second user medium in the passenger compartment when the formed absolute values do not exceed a specified tolerance and when measured values from at least the second sensor exceed a specified threshold value.

19. The method as claimed in claim 18, further comprising:
ascertaining presence for the at least first user medium in an event of failure of the at least first sensor failing, at least temporarily, solely based on the second sensor, and in an event of the second sensor failing, at least temporarily, based solely on the at least first sensor.
